(19) United States
(12) Patent Application Publication
(10) Pub. No.: US 2012/0162017 A1
(43) Pub. Date: Jun. 28, 2012

(54) MULTIBAND ANTENNA

(75) Inventor: YI-CHIEH LEE, Tu-Cheng (TW)

(73) Assignee: CHI MEI COMMUNICATION SYSTEMS, INC., Tu-Cheng (TW)

(21) Appl. No.: 13/038,478

(22) Filed: Mar. 2, 2011

(30) Foreign Application Priority Data
Dec. 28, 2010 (TW) 99146447

(51) Int. Cl. H01Q 5/01

(52) U.S. Cl. 343/700 MS

(57) ABSTRACT

A multiband antenna includes a feed unit, a first radio unit, a second radio unit, and a resonance unit. When feed signals are input from the feed unit, the feed signals are respectively transmitted to the first radio unit and the second radio unit to enable the first radio unit and the second radio unit to respectively receive and send wireless signals of different frequencies, and the resonance unit is driven to resonate and is thereby enabled to receive and send wireless signals of predetermined frequencies, such that the multiband antenna is capable of receiving and sending wireless signals in more than two frequency bands.

### BACKGROUND

1. Technical Field

The present disclosure relates to multiband communication technology, and particularly to a multiband antenna for portable electronic devices.

2. Description of Related Art

Portable electronic devices, such as mobile phones, personal digital assistants (PDA), and laptop computers, often utilize mounted antennas for receiving/sending wireless signals. Commonly, a portable electronic device may receive/send wireless signals of different frequencies, requiring the presence of a multiband antenna.

However, multiband antennas tend to be large with complicated structure, compromising efforts toward minimization of portable electronic device size. Even where installation of miniaturized multiband antennas within such portable electronic devices is possible, communication capabilities of miniaturized multiband antennas may be adversely affected due to their limited size. For example, many multiband antennas used in portable electronic devices are unable to receive/send wireless signals in more than two frequency bands.

Therefore, there is room for improvement within the art.

### BRIEF DESCRIPTION OF THE DRAWINGS

Many aspects of the present multiband antenna can be better understood with reference to the following drawings. The components in the various drawings are not necessarily drawn to scale, the emphasis instead being placed upon clearly illustrating the principles of the present multiband antenna. Moreover, in the drawings, like reference numerals designate corresponding parts throughout the figures.

FIG. 1 is a schematic view of a multiband antenna, according to a first exemplary embodiment.

FIG. 2 is a schematic view of the multiband antenna shown in FIG. 1, viewed from another angle.

FIG. 3 is a diagram showing RL (return loss) measurement of the multiband antenna shown in FIG. 1.

FIG. 4 is a schematic view of a multiband antenna, according to a second exemplary embodiment.

FIG. 5 is a schematic view of a multiband antenna, according to a third exemplary embodiment.

FIG. 6 is a schematic view of a multiband antenna, according to a fourth exemplary embodiment.

### DETAILED DESCRIPTION

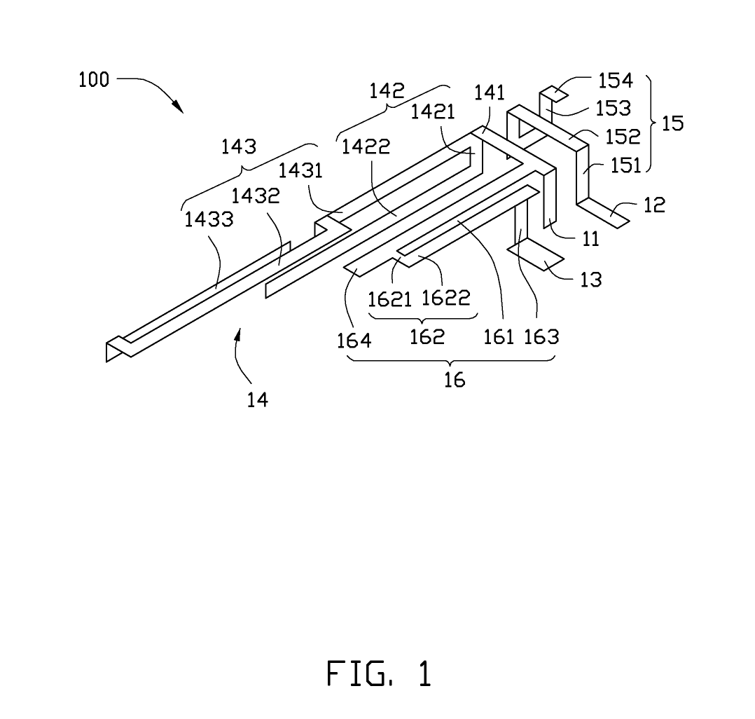

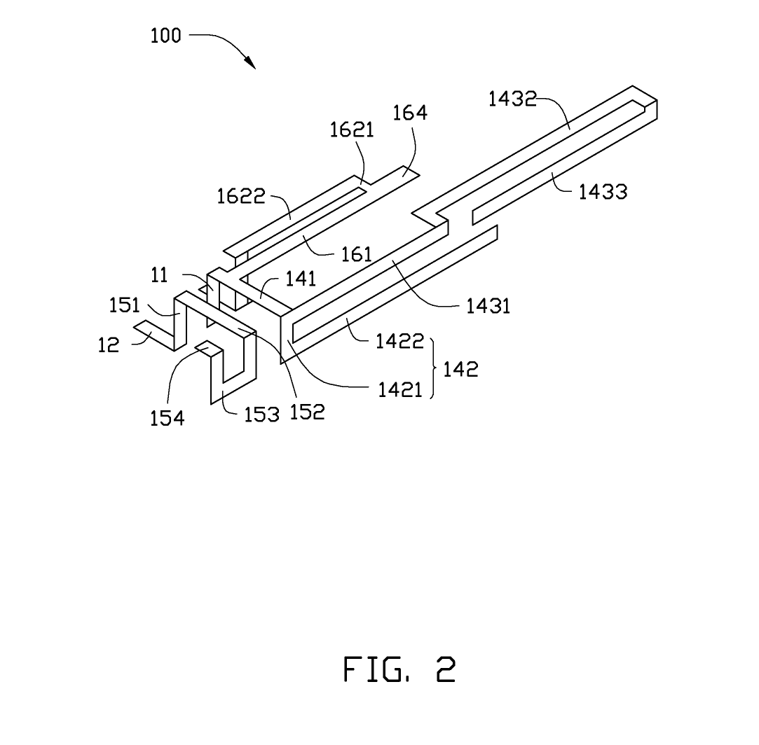

FIG. 1 and FIG. 2 schematically show a multiband antenna 100, according to an exemplary embodiment. The multiband antenna 100 consists of conductive sheets, such that size and profile thereof are minimized, meeting suitability for use in a portable electronic device such as a mobile phone, a personal digital assistant (PDA), or a laptop computer. The conductive sheets can be flexible printed circuits (FPC) or other material. Particularly, the multiband antenna 100 includes a feed unit 11, a first grounded unit 12, a second grounded unit 13, a first radio unit 14, a resonance unit 15, and a second radio unit 16.

The feed unit 11 is a planar sheet. The first grounded unit 12 and the second grounded unit 13 are both planar sheets for connection to a ground, and are both positioned in a same plane that is perpendicular to the plane in which the feed unit 11 is positioned.

The first radio unit 14 includes a feed portion 141, a first main radio portion 142, and a second main radio portion 143. The feed portion 141 is a longitudinal planar sheet positioned in a plane that is parallel to the plane in which the first grounded unit 12 and the second grounded unit 13 are positioned. One end of the feed portion 141 is perpendicularly connected to the feed unit 11, and the other is connected to the first main radio portion 142. The first main radio portion 142 is an L-shaped planar sheet positioned in a plane that is parallel to the plane in which the feed unit 11 is positioned. Particularly, the first main radio portion 142 includes a first radio section 1421 and a second radio section 1422, which are both longitudinal planar sheets. The first radio section 1421 is shorter than the second radio portion 1422. The first radio section 1421 has one end perpendicularly connected to the feed portion 141 and the other perpendicularly connected to the second radio section 1422. A side of the first radio portion 1421, which is adjacent to the end of the first radio section 1421 connected to the feed portion 141, is connected to the second main radio portion 143.

The second main radio portion 143 includes a third radio section 1431, a fourth radio section 1432, and a fifth radio section 1433. The third radio section 1431 is a longitudinal planar sheet positioned coplanar with the first main radio section 142 and extending parallel to the second radio section 1422. One end of the third radio section 1431 is connected to the aforementioned side of the first radio section 1421. A side of the third radio section 1431, which is adjacent to another end of the third radio section 1431, is connected to the fourth radio section 1432. The fourth radio section 1432 is an approximately U-shaped planar sheet positioned coplanar with the feed portion 141. The fourth radio section 1432 includes a longitudinal first main part (not labeled) and two first arms (not labeled) respectively perpendicularly connected to two ends of the same side of the first main part. A distal end of one arm is perpendicularly connected to the aforementioned side of the third radio section 1431. The fifth radio section 1433 is a longitudinal planar sheet positioned coplanar with the first main radio portion 142 and the third radio section 1431. A distal end of another arm of the fourth radio section 1432 is perpendicularly connected to a side adjacent to an end of the fifth radio section 1433. The fifth radio section 1433 is positioned parallel to the second radio section 1422 and approximately collinear with the third radio section 1431, and extends towards the third radio section 1431.

The second radio unit 16 is positioned at the same side of the feed portion 141 as the second radio section 1422 and the second main radio portion 143. The second radio unit 16 includes a first subsidiary radio portion 161, a second subsidiary radio portion 162, a main grounding portion 163, and a third subsidiary radio portion 164. The first subsidiary radio portion 161 is a longitudinal planar sheet positioned coplanar with the feed portion 141 and the fourth radio section 1432 and extending parallel to the fourth radio section 1432. One end of the first subsidiary radio portion 161 is perpendicularly connected to the feed portion 141 and is positioned adjacent to the feed unit 11. The second subsidiary radio portion 162 is an L-shaped planar sheet positioned coplanar with the feed portion 141, the fourth radio section 1432, and the first subsidiary radio portion 161. The second subsidiary radio portion 162 includes a sixth radio section 1621 and a seventh radio section 1622. Both the sixth radio section 1621 and the seventh radio section 1622 are longitudinal planar sheets, and the sixth radio section 1621 is shorter than the seventh radio section 1622. The sixth radio section 1621 and the seventh radio section 1622 are perpendicularly connected to each other. Another end of the first subsidiary radio portion 161 is perpendicularly connected to the same side of the sixth radio section 1621 as the seventh radio section 1622, such that the seventh radio section 1622 extends parallel to the first subsidiary radio portion 161 and the fourth radio section 1432.

The main grounding portion 163 is a planar sheet positioned coplanar with the feed unit 11. Two ends of the main grounding portion 163 are respectively perpendicularly connected to the seventh radio section 1622 and the second grounded unit 13. The third subsidiary radio portion 164 is a longitudinal planar sheet positioned coplanar with the first subsidiary radio portion 161, the second subsidiary portion 162, the feed portion 141, and the fourth radio section 1432. One end of the third subsidiary radio portion 164 is perpendicularly connected to a side of the sixth radio section 1621 that is opposite to the side of the sixth radio section 1621 connected to the seventh radio section 1622 and the first subsidiary radio portion 161. The third subsidiary radio portion 164 extends parallel to the seventh radio section 1622 and the and the fourth radio section 1432, and is further positioned approximately collinear with the first subsidiary radio portion 161.

The resonance unit 15 is positioned adjacent to but separated from the feed unit 11, the first radio unit 14 and the second unit 16. The resonance unit 15 includes a subsidiary grounding portion 151, a first resonance portion 152, a second resonance portion 153, and a third resonance portion 154. The subsidiary grounding portion 151 is a longitudinal planar sheet positioned coplanar with and parallel to the feed unit 11 and the main grounding portion 163. The first resonance portion 152 is a longitudinal planar sheet positioned coplanar with and parallel to the feed portion 141. The second resonance portion 153 is an approximately U-shaped planar sheet positioned coplanar with the first main radio section 142 and the third radio section 1431. The second resonance portion 153 includes a longitudinal second main part (not labeled) and two longitudinal second arms (not labeled) respectively perpendicularly connected to two ends of a same side of the second main part. The second main part is positioned approximately collinear with the second radio section 1422, and the two second arms are positioned parallel to the first radio section 1421. The third resonance portion 154 is a longitudinal planar sheet positioned coplanar with and parallel to the feed portion 141 and the first resonance portion 152. Two ends of the subsidiary grounding portion 151 are respectively perpendicularly connected to the first grounded unit 12 and an end of the first resonance portion 152. Another end of the first resonance portion 152 is perpendicularly connected to a distal end of one second arm. The third resonance portion 154 is perpendicularly connected to a distal end of another second arm.

When the multiband antenna 100 is used, the first grounded unit 12 and the second grounded unit 13 can be attached to a circuit board (not shown) of the portable electronic device to be grounded, and the feed unit 11 is connected to the circuit board to receive feed signals. Feed signals input from the feed unit 11 and the feed portion 141 can be respectively transmitted to the first main radio portion 142, the second main radio portion 143, and the second radio unit 16 to form a plurality of current paths of different lengths, and thus the first main radio portion 142, the second main radio portion 143, and the second radio unit 16 are respectively enabled to serve as antenna members for receiving and sending wireless signals at different frequencies. Simultaneously, the resonance unit 15 is driven to resonate due to current through the first main radio portion 142, the second main radio portion 143, and the second radio unit 16, and thereby is also enabled to serve as an antenna member for receiving and sending wireless signals of predetermined frequencies. In this way, the multiband antenna 100 can be used to receive and send wireless signals in a plurality of different frequency bands.

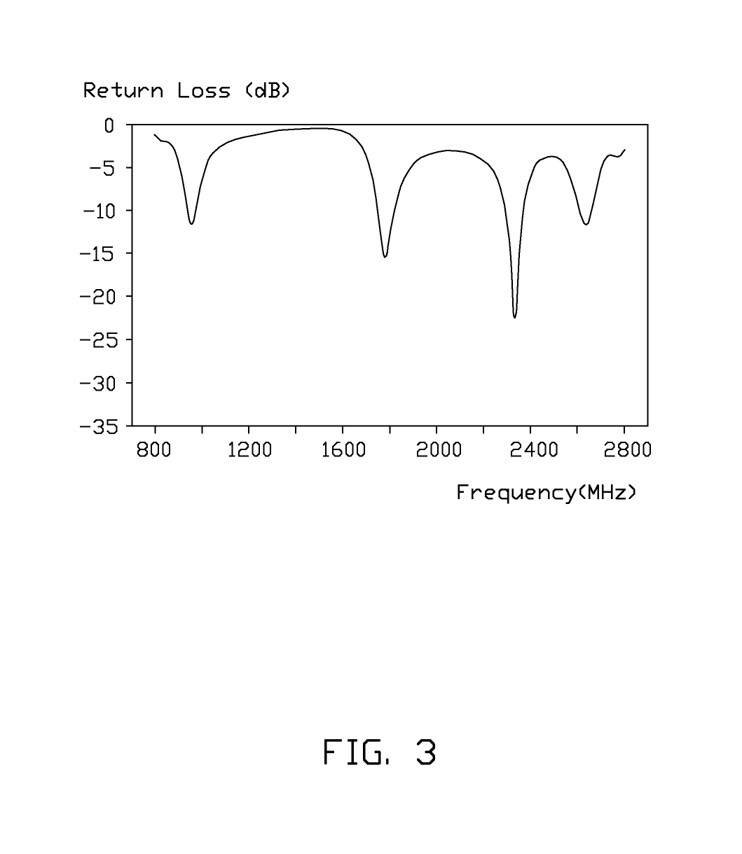

Referring to FIG. 3, as shown in experiments, the return loss (RL) of the multiband antenna 100 is acceptable when the multiband antenna 100 receives/sends wireless signals in multiple frequency bands. Particularly, the RL of the multiband antenna 100 is less than −5 dB when the multiband antenna 100 receive/send wireless signals at frequencies of about 900 MHz, 1800 MHz, 2300 MHz, and 2700 MHz. Accordingly, the electronic device employing the multiband antenna 100 can be used in a plurality of (more than two) common wireless communication systems, such as GSM900, DCS1800, PCS1900, UMTS2100, etc., with acceptable communication quality.

Due to the composition disclosed, in assembly, the multiband antenna 100 can be supported and protected on a cubic substrate (not shown). Particularly, the feed portion 141, the fourth radio section 1432, the first resonance portion 152, the third resonance portion 154, the first subsidiary radio portion 161, the second subsidiary radio portion 162, and the third subsidiary radio portion 164 can be attached on a top surface of the substrate. The feed unit 11, the main grounding portion 163, and the subsidiary grounding portion 151 can be attached on a side surface of the substrate. The first main radio portion 141, the third radio section 1431, the fifth radio section 1433, and the second resonance portion 153 can be attached on another side surface of the substrate that is opposite to the side surface for mounting the feed unit 11, the main grounding portion 163, and the subsidiary grounding portion 151. Thus, most parts of the multiband antenna 100 can be flatly attached on the substrate, with an outer shape of an assembly including the substrate and the multiband antenna 100 mounted thereon also approximately cubic. Accordingly, the multiband antenna 100 is protected from damage, and assembly, installation, and transportation of the multiband antenna 100 are simplified.

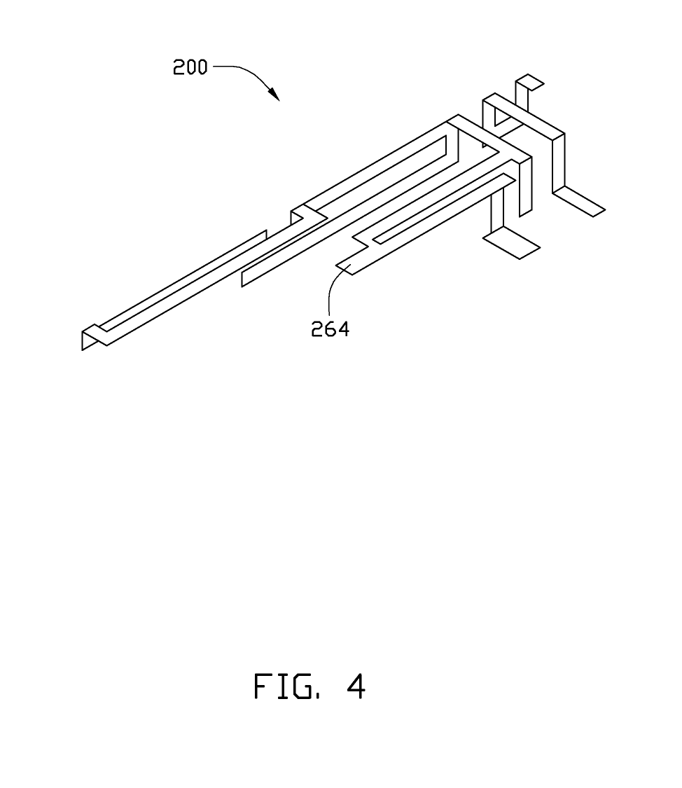

FIG. 4 shows a multiband antenna 200, according to a second exemplary embodiment, differing form the multiband antenna 100 only in that the third subsidiary radio portion 164 is replaced by a fourth subsidiary radio portion 264. Features of the fourth subsidiary radio portion 264 are similar to features of the third subsidiary radio portion 164, except that the fourth subsidiary radio portion 264 is positioned approximately collinear with the seventh radio section 1622.

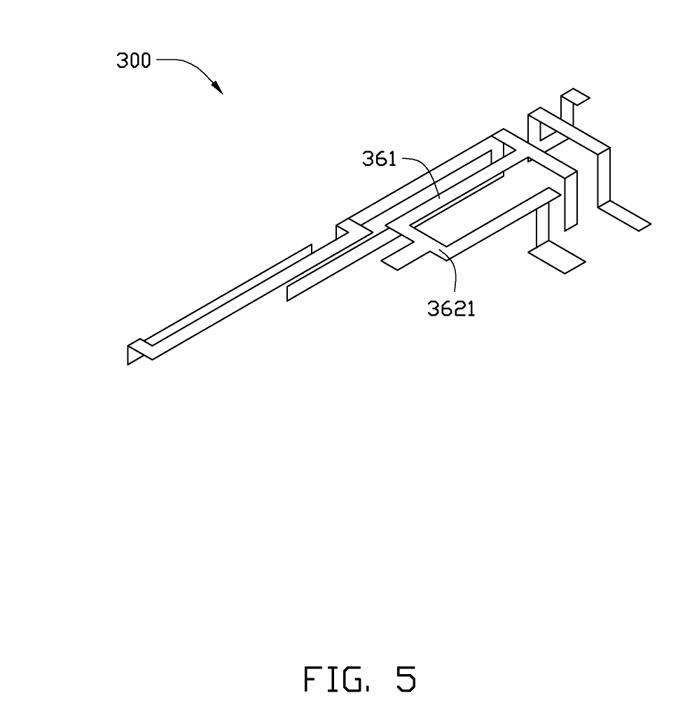

FIG. 5 shows a multiband antenna 300, according to a third exemplary embodiment, differing from the multiband antenna 100 only in that the first subsidiary radio portion 161 and the sixth radio section 1621 are respectively replaced by a fifth subsidiary radio portion 361 and an eighth radio section 3621. Features of the fifth subsidiary radio portion 361 and the eighth radio section 3621 are correspondingly similar to features of the first subsidiary radio portion 161 and the sixth radio section 1621, except that the eighth radio section 3621 is longer than the sixth radio section 1621 and extends closer to the third radio section 1431 than the sixth radio section 1621, and thus the fifth subsidiary radio portion 361 is farther away from the seventh radio section 1622 and closer to the third radio section 1431 than the first subsidiary radio portion 161, and the third subsidiary radio portion 164 is not collinear with but parallel to the fourth subsidiary radio portion 361.

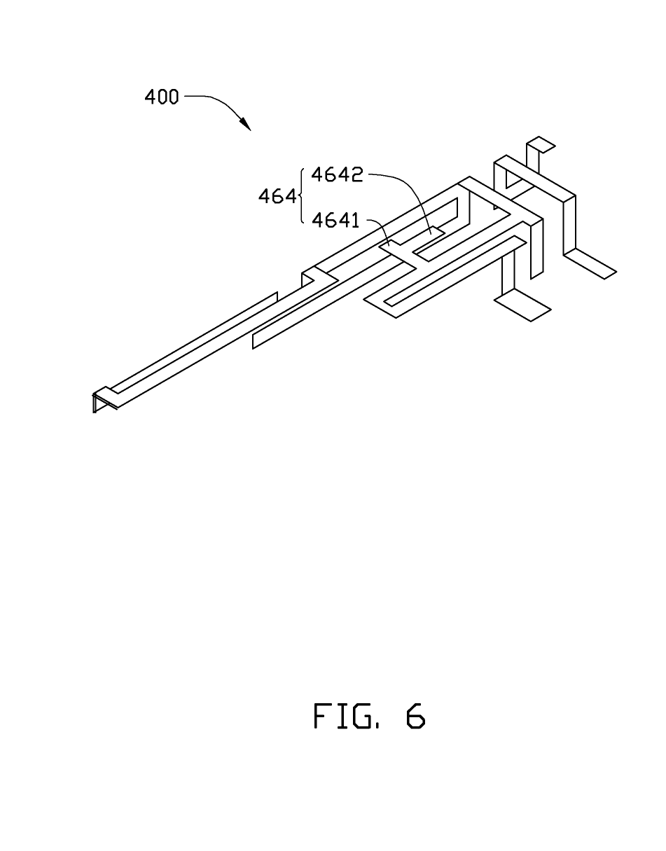

FIG. 6 shows a multiband antenna 400, according to a fourth exemplary embodiment, differing from the multiband antenna 100 only in that the third subsidiary radio portion 164 is replaced by a sixth subsidiary radio portion 464. The sixth subsidiary radio portion 464 is a planar sheet positioned between the first subsidiary radio portion 161 and the third radio section 1431, and coplanar with the first subsidiary radio portion 161, the second subsidiary portion 162, the feed portion 141, and the fourth section 1432. The sixth subsidiary radio portion 464 includes a ninth radio section 4641 and a tenth radio section 4642, which are both longitudinal planar sheets. The ninth radio section 4641 is perpendicularly connected to a side of the first subsidiary radio portion 161 and extends towards the third radio section 1431. The tenth radio section 4642 is perpendicularly connected to a side of the ninth radio section 4641 and extends towards the feed portion 141, parallel to the first subsidiary radio portion 161 and the seventh radio section 1622.

It is to be further understood that even though numerous characteristics and advantages of the present embodiments have been set forth in the foregoing description, together with details of structures and functions of various embodiments, the disclosure is illustrative only, and changes may be made in detail, especially in matters of shape, size, and arrangement of parts within the principles of the present invention to the full extent indicated by the broad general meaning of the terms in which the appended claims are expressed.

What is claimed is:

1. A multiband antenna, comprising:
a feed unit;
a first radio unit including a feed portion, a first main radio portion, and a second radio portion, the feed portion connected to the feed unit, the first main radio portion and the second radio portion both connected to the feed portion;
a second radio unit connected to the feed unit; and
a resonance unit positioned adjacent to but separate from the feed unit, the first radio unit, and the second radio unit; wherein when feed signals are input from the feed unit and the feed portion, the feed signals are respectively transmitted to the first main radio portion, the second main radio portion, and the second radio unit to enable the first main radio portion, the second main radio portion, and the second radio unit to respectively receive and send wireless signals of different frequencies, and the resonance unit is driven to resonate and is thereby enabled to receive and send wireless signals of predetermined frequencies, such that the multiband antenna is capable of receiving and sending wireless signals in more than two frequency bands.

2. The multiband antenna as claimed in claim 1, further comprising a first grounded unit connected to the resonance unit and a second grounded unit connected to the second radio unit, wherein the first grounded unit and the second grounded unit are both sheets and positioned coplanar with each other.

3. The multiband antenna as claimed in claim 2, wherein the feed unit and the feed portion are both sheets and are respectively positioned in two planes that are perpendicular to each other.

4. The multiband antenna as claimed in claim 3, wherein the first main radio portion is a sheet positioned in a plane that is parallel to the plane in which the feed unit is positioned.

5. The multiband antenna as claimed in claim 4, wherein the first main radio portion is L-shaped and includes a first radio section and a second radio section, which are both longitudinal sheets; the first radio section having one end connected to the feed portion and another end connected to the second radio section.

6. The multiband antenna as claimed in claim 5, wherein the second main radio portion includes a third radio section, a fourth radio section, and a fifth radio section; the third radio section, the fourth radio section, and the fifth radio section being sheets, the third radio section and the fifth radio section positioned coplanar with the first main radio section, and the fourth radio section positioned coplanar with the feed portion.

7. The multiband antenna as claimed in claim 6, wherein the third radio section is a longitudinal sheet extending parallel to the second radio section, one end of the third radio section connected to a side of the first radio portion that is adjacent to the end of the first radio section connected to the feed portion; the fourth radio section includes a longitudinal first main part and two first arms respectively connected to two ends of a same side of the first main part, a distal end of one arm connected to a side of the third radio section that is adjacent to another end of the third radio section; the fifth radio section is a longitudinal sheet that is positioned parallel to the second radio section and collinear with the third radio section, and extends towards the third radio portion, a distal end of another arm of the fourth radio section connected to a side adjacent to an end of the fifth radio section.

8. The multiband antenna as claimed in claim 3, wherein the second radio unit is positioned at the same side of the feed portion as the second main radio portion.

9. The multiband antenna as claimed in claim 8, wherein the second radio unit includes a first subsidiary radio portion and a second subsidiary radio portion, the first subsidiary radio portion being a longitudinal sheet positioned coplanar with the feed portion, one end of the first subsidiary radio portion connected to the feed portion; the second subsidiary radio portion being an L-shaped sheet that is positioned coplanar with the feed portion and the first subsidiary radio portion, and includes a sixth radio section and a seventh radio section; the sixth radio section and the seventh radio section being longitudinal sheets connected to each other, another end of the first subsidiary radio portion connected to the same side of the sixth radio section as the seventh radio section, such that the seventh radio section extends parallel to the first subsidiary radio portion.

10. The multiband antenna as claimed in claim 9, wherein the second radio unit further includes a main grounding portion, which is a sheet positioned coplanar with the feed unit; two ends of the main grounding portion respectively connected to the seventh radio section and the second grounded unit.

11. The multiband antenna as claimed in claim 9, wherein the second radio unit further includes a third subsidiary radio portion that is a sheet positioned coplanar with the first subsidiary radio portion, the second subsidiary portion, and the feed portion.

12. The multiband antenna as claimed in claim 11, wherein the third subsidiary radio portion is a longitudinal sheet, one end of the third subsidiary radio portion connected to a side of the sixth radio section that is opposite to the side of the sixth radio section connected to the seventh radio section and the first subsidiary radio portion.

13. The multiband antenna as claimed in claim 12, wherein the third subsidiary portion is positioned collinear with the first subsidiary radio portion or the seventh radio section.

14. The multiband antenna as claimed in claim 11, wherein the third subsidiary radio portion includes a ninth radio section and a tenth radio section, which are both longitudinal sheets; the ninth radio section connected to the first subsidiary radio portion and extends towards the first radio unit, the tenth radio section connected to the ninth radio section and extends towards the feed portion, parallel to the first subsidiary radio portion and the seventh radio section.

15. The multiband antenna as claimed in claim 4, wherein the resonance unit includes a subsidiary grounding portion, a first resonance portion, a second resonance portion, and a third resonance portion; the subsidiary grounding portion being a longitudinal sheet positioned coplanar with and parallel to the feed unit, the first resonance portion being a longitudinal sheet positioned coplanar with and parallel to the feed portion, the second resonance portion being a U-shaped planar sheet positioned coplanar with the first main radio section and including a longitudinal second main part and two longitudinal second arms respectively connected to two ends of a same side of the second main part, the third resonance portion being a longitudinal sheet positioned coplanar with and parallel to the feed portion and the first resonance portion; two ends of the subsidiary grounding portion respectively connected to the first grounded unit and an end of the first resonance portion, another end of the first resonance portion connected to a distal end of one second arm, and the third resonance portion connected to a distal end of another second arm.
